(19) United States
(12) Patent Application Publication
(10) Pub. No.: US 2022/0242432 A9
(43) Pub. Date: Aug. 4, 2022

(54) ENCOUNTER WARNING METHOD AND ENCOUNTER WARNING SYSTEM

(71) Applicant: Ford Global Technologies, LLC, Dearborn, MI (US)

(72) Inventors: YING HUANG, Shanghai (CN); TOMMY POEK, Singkawang (ID)

(73) Assignee: Ford Global Technologies, LLC, Dearborn, MI (US)

(21) Appl. No.: 16/775,768

(22) Filed: Jan. 29, 2020

(30) Foreign Application Priority Data
Apr. 1, 2019 (CN) 2019102569185

(51) Int. Cl. B60W 50/14; G08G 1/16; G06K 9/00; B60W 40/09; G06F 16/903

(52) U.S. Cl. CPC B60W 50/14; G08G 1/166; B60W 2050/143; B60W 40/09; G06F 16/903; G06K 9/00805

(57) ABSTRACT

Disclosed is an encounter warning method, comprising: determining an approach direction and a threat level of an approaching target with respect to a host vehicle; and activating a plurality of indicators sequentially in the approach direction based on the threat level so as to indicate, to a driver, the approach direction. The method prompts a driver of an approach direction of a distant target in a manner of motion display (e.g., a flashing light strip or a moving marker), and displays the approach direction dynamically and differentially based on an emergency level of the distant target.

### CROSS-REFERENCE TO RELATED APPLICATIONS

This patent application claims priority to Chinese Application 2019102569185.5, filed on Apr. 1, 2019, which application is hereby incorporated herein by reference in its entirety.

### TECHNICAL FIELD

The present disclosure generally relates to providing an encounter warning method for a vehicle.

### BACKGROUND

Collision control/avoidance systems and methods have been widely used to avoid collisions between two vehicles. In particular, a host vehicle may have a plurality of sensors arranged at different locations. The sensors collectively detect the presence of distant vehicles that approach the host vehicle, particularly those vehicles that may present potential collision threats. Position coordinates of the host vehicle and the target vehicles may also be determined by a vehicle-to-vehicle communication system (V2V), a vehicle-to-infrastructure (V2I), a radar, a GPS, or a vision-based system disposed on the host vehicle. A collision warning signal is then provided to a passenger of the host vehicle. As such, if a distant vehicle is obscured by an obstacle and cannot be seen by the driver, then the collision warning signal can still help the driver understand the relevant situation in time.

A collision warning system for an intersection is disclosed in U.S. Pat. No. 8,618,952. The solution operates in a normal warning mode when a collision threat level is lower and in an enhanced warning mode when the threat level is higher. In different warning modes, different static pictures are provided to a driver, and the direction of a distant vehicle is indicated by a static arrow.

### SUMMARY

According to one aspect, an encounter warning method is disclosed, comprising: determining an approach direction and a threat level of an approaching target with respect to a host vehicle; and activating a plurality of indicators sequentially in the approach direction based on the threat level so as to indicate, to a driver, the approach direction.

In one embodiment, the determining the approach direction and the threat level of the approaching target, with respect to a host vehicle comprises: receiving information of the host vehicle; receiving information of one or a plurality of distant targets; and determining the approaching target from the one or a plurality of distant targets and storing data of the approaching target, the data comprising the approach direction and the threat level of the approaching target with respect to the host vehicle.

In one embodiment, the determining the approaching target comprises: determining a threat level of the host vehicle encountering the one or a plurality of distant targets based on the information of the host vehicle and the one or a plurality of distant targets; and determining the approaching target from the one or a plurality of distant targets based on the threat level.

In one embodiment, the activating a plurality of indicators sequentially based on the threat level comprises determining a first time interval based on the threat level, turning on the plurality of indicators sequentially at the first time interval so as to present a flowing light strip or a moving marker for indicating the approach direction, and then causing the plurality of indicators to be turned off.

In one embodiment, the plurality of indicators comprise a first indicator, a second indicator, and a third indicator arranged in a transverse direction of the host vehicle, and the activating a plurality of indicators sequentially based on the threat level comprising determining the first time interval based on the threat level; at a first time, enabling the first indicator to emit light continuously for the first time interval; at a second time, enabling the second indicator to emit light continuously for the first time interval; at a third time, enabling the third indicator to emit light continuously for a certain time interval; and at a fourth time, causing the first indicator, the second indicator, and the third indicator to be turned off.

In one embodiment, the plurality of indicators comprise a first indicator, a second indicator, and a third indicator arranged in a transverse direction of the host vehicle, the activating the plurality of indicators sequentially based on the threat level comprising determining the first time interval based on the threat level; at a first time, enabling the first indicator to emit light continuously for the first time interval; at a second time, causing the first indicator to stop emitting light and simultaneously enabling the second indicator to emit light continuously for the first time interval; at a third time, causing the second indicator to stop emitting light and simultaneously enabling the third indicator to emit light continuously for a certain time interval; and at a fourth time, causing the first indicator, the second indicator, and the third indicator to be turned off.

In one embodiment, the first time interval is between 100 ms and 200 ms.

In one embodiment, the plurality of indicators comprise a first set of LED lights and a second set of LED lights arranged close to, i.e., proximal to, a front window of the vehicle, and the turning on the plurality of indicators sequentially in the approach direction at the first time interval comprising turning on the first set of LED lights sequentially at the first time interval from left to right in response to the approaching target approaching the host vehicle from a left side of the host vehicle so that the first set of LED lights emit light presenting a rightward arrow, and turning on the second set of LED lights sequentially at the first time interval from right to left in response to the approaching target approaching the host vehicle from a right side of the host vehicle so that the second set of LED lights emit light presenting a leftward arrow.

In one embodiment, the method further comprises activating the plurality of indicators simultaneously in response to the approaching target approaching the host vehicle from a front side of the host vehicle.

In one embodiment, the activating a plurality of indicators sequentially based on the threat level comprises turning on the plurality of indicators sequentially at the first time interval, and then causing the plurality of indicators for a second time interval to be turned off, wherein the second time interval is determined based on the threat level.

According to another aspect, a vehicle encounter warning system is disclosed, comprising: a plurality of indicators; and a controller configured to: receive information of a host vehicle; receive data of an approaching target, the data comprising an approach direction and a threat level of the approaching target with respect to the host vehicle; and activate the plurality of indicators sequentially in the approach direction based on the threat level to form a moving pattern for indicating the approach direction.

In one embodiment, the plurality of indicators are arranged close to a front window of the vehicle and arranged in a transverse direction of the host vehicle, and the controller is configured to activate the plurality of indicators sequentially from left to right in response to the approaching target approaching the host vehicle from a left side of the host vehicle, and activate the plurality of indicators sequentially from right to left in response to the approaching target approaching the host vehicle from a right side of the host vehicle.

In one embodiment, the controller is further configured to activate the plurality of indicators simultaneously in response to the approaching target approaching the host vehicle from a front side of the host vehicle.

In one embodiment, the activating the plurality of indicators sequentially based on the threat level comprises determining a first time interval based on the threat level, turning on the plurality of indicators sequentially at the first time interval, and then causing the plurality of indicators to be turned off.

In one embodiment, the activating the plurality of indicators sequentially based on the threat level comprises turning on the plurality of indicators sequentially at the first time interval, and then causing the plurality of indicators for a second time interval to be turned off, wherein the second time interval is determined based on the threat level.

In one embodiment, the plurality of indicators comprise a first set of LED lights and a second set of LED lights arranged generally in a transverse direction of the host vehicle, the first set of LED lights and the second set of LED lights form a part of a heads-up display, and the activating the plurality of indicators sequentially in the approach direction comprises activating the first set of LED lights sequentially from left to right in response to the approaching target approaching the host vehicle from a left side of the host vehicle, and activating the second set of LED lights sequentially from right to left in response to the approaching target approaching the host vehicle from a right side of the host vehicle.

In one embodiment, the first set of LED lights and the second set of LED lights have at least partially shared LED lights.

In one embodiment, the plurality of indicators comprise a plurality of virtual icons located on a display of the host vehicle.

According to still another aspect, a vehicle encounter warning method is disclosed, comprising: determining an approach direction of an approaching target with respect to a host vehicle; determining a threat level of the approaching target with respect to the host vehicle; turning on a plurality of indicators sequentially from left to right at a longer time interval in response to the determination that the approaching target is approaching the host vehicle from a left side of the host vehicle and the determined threat level is lower, and turning on the plurality of indicators sequentially from left to right at a shorter time interval in response to the determination that the approaching target is approaching the host vehicle from the left side of the host vehicle and the determined threat level is higher; and turning on the plurality of indicators sequentially from right to left at a longer time interval in response to the determination that the approaching target is approaching the host vehicle from a right side of the host vehicle and the determined threat level is lower, and turning on the plurality of indicators sequentially from right to left at a shorter time interval in response to the determination that the approaching target is approaching the host vehicle from the right side of the host vehicle and the determined threat level is higher.

In one embodiment, the method further comprises activating the plurality of indicators simultaneously in response to the determination that the approaching target is approaching the host vehicle from a front side of the host vehicle.

The encounter warning method according to one or a plurality of embodiments of the present disclosure enables a user to quickly determine a direction of a vehicle that may have a potential collision threat and the degree of danger thereof without directing user sight away from the road ahead, thus enhancing user experience.

It should be understood that the foregoing brief description is provided for briefly introducing a series of selected concepts that will be further described in the detailed description, and critical or basic features of the present claims are not limited to the concepts included in the foregoing brief description. Further, the claims are not limited to implementations that overcome any disadvantages described above or in any part of this description.

The features and/or advantages are apparent by the description of one or a plurality of embodiments described in detail below separately or with reference to the accompanying drawings.

### BRIEF DESCRIPTION OF THE DRAWINGS

In order to better understand one or a plurality of embodiments of the present disclosure, specific embodiments are described in more detail through examples in the description of the present application with reference to the accompanying drawings. In the drawings:

FIG. 1 schematically shows an environment of implementing an encounter warning method.

FIG. 2 schematically shows a plurality of indicators.

FIG. 3 schematically shows an advanced flowchart of an encounter warning method.

FIG. 4 schematically shows an external environment of a vehicle in an encounter warning method.

FIG. 5 schematically shows a flowchart of determining information of an approaching target.

FIG. 6 schematically shows a control policy of a plurality of indicators.

FIG. 7 schematically shows a flowchart of the control policy shown in FIG. 6;

FIG. 8 schematically shows another control policy of a plurality of indicators.

FIG. 9 schematically shows a flowchart of the control policy shown in FIG. 8;

FIG. 10 schematically shows another control policy of a plurality of indicators.

FIG. 11 schematically shows a flowchart of the control policy shown in FIG. 10;

FIG. 12 schematically shows a flowchart of determining a direction of activating a plurality of indicators.

FIG. 13 schematically shows a control policy of activating a plurality of indicators simultaneously.

FIG. 14 schematically shows a plurality of indicators.

### DETAILED DESCRIPTION

Specific embodiments are disclosed in the description of the present application; however, it should be understood that the embodiments disclosed here are only examples that can be implemented in various alternative forms. The accompanying drawings are not necessarily drawn proportionally; some features may be scaled up or down to show details of specific components. The same or similar reference numerals can indicate the same parameters and components or similar modifications and replacements. In the following description, a plurality of operational parameters and components are described in a plurality of conceived embodiments. These specific parameters and components are used in this description as examples only and are not meant to be limiting. Therefore, specific structural and functional details disclosed in this description should not be construed as limiting, but are merely exemplary.

In the description, it should be understood that orientation or positional relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, and “counterclockwise” are orientation or positional relationships shown based on the accompanying drawings, and are merely used for the convenience of description and simplification of the description, and do not indicate or imply that a device or component referred to must have a specific orientation and must be constructed and operated in a specific orientation, and thus they should not be construed as limiting.

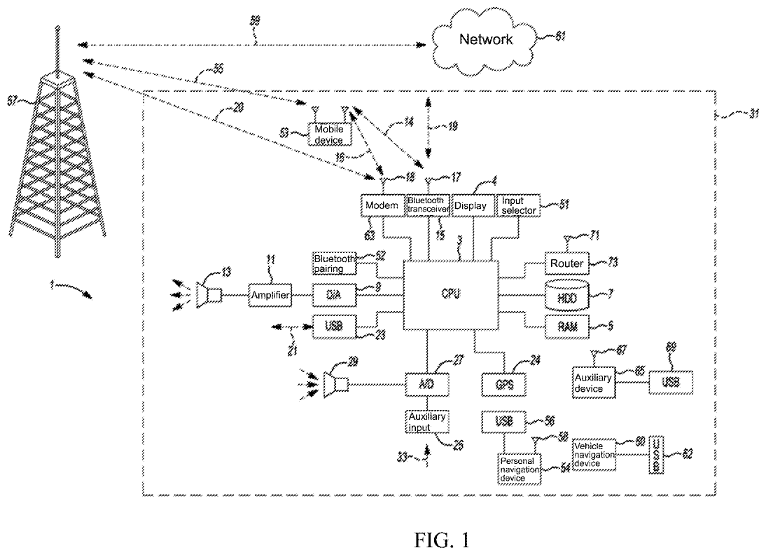

FIG. 1 shows an exemplary block topology diagram of a vehicle computing system (VCS) 1 for a vehicle 31. An example of such a vehicle-based computing system 1 is the SYNC system manufactured by the Ford Motor Company. A vehicle provided with the vehicle-based computing system may include a visual front-end interface or display 4 located in the vehicle. If the interface 4 is provided with, for example, a touch screen, then a user can still interact with the interface 4. In another illustrative embodiment, the user can interact with the interface 4 by pressing a button or speaking to a spoken dialogue system provided with automatic speech recognition and speech synthesis.

In the illustrative embodiment 1 shown in FIG. 1, a processor (CPU) 3 controls at least a part of operations of the vehicle-based computing system. The processor 3 disposed in the vehicle allows in-vehicle processing of commands and programs. In addition, the processor 3 is connected to both a non-persistent memory 5 and a persistent memory 7. In this illustrative embodiment, the non-persistent memory is a random access memory (RAM), and the persistent memory is a hard disk drive (HDD) or a flash memory. In general, the persistent (non-transitory) memory may include all forms of memories that hold data when a computer or another device encounters a power failure. These memories include, but are not limited to, an HDD, a CD, a DVD, a magnetic tape, a solid state drive, a portable USB drive, and any other suitable form of a persistent memory.

The processor is also provided with a plurality of different inputs that allow the user to interact with the processor. In the illustrative embodiment, a microphone 29, an auxiliary input 25 (for an input 33), a USB input 23, a GPS input 24, a screen 4 (which may be a touch screen display), and a Bluetooth input 15 are all provided. An input selector 51 is also provided to allow the user to switch between the various inputs. The input to both the microphone 29 and the auxiliary connector 25 is analog-to-digital converted by a converter 27 before being transmitted to the processor. Although not shown, a plurality of vehicle components and auxiliary components in communication with the VCS can transmit data to the VCS 1 (or components thereof) and transmit data from the VCS (or components thereof) by using a vehicle network (for example, but not limited to, a CAN bus).

The output of the system may include, but is not limited to, the visual display 4 such as a heads-up display (HUD) and a speaker or stereo system output. A speaker 13 is connected to an amplifier 11 and receives signals from the processor 3 by means of a digital to analog converter (D/A) 9. Outputs to a remote Bluetooth device (such as a personal navigation device (PND) 54) or a USB device (such as a vehicle navigation device 60) may also be generated along bi-directional data streams shown by 19 and 21, respectively.

In an illustrative embodiment, the system 1 uses a Bluetooth transceiver 15 to communicate (17) with a mobile device 53 (e.g., a cellphone, a smart phone, a PDA, or any other connected device having wireless remote network connectivity) of the user. The mobile device 53 can then be used to communicate (59) with a network 61 external to the vehicle 31 by means of, for example, communication (55) with a cellular tower 57. In some embodiments, the cellular tower 57 may be a WiFi access point.

Exemplary communication between the mobile device 53 and the Bluetooth transceiver 15 is represented by a signal 14. Pairing the mobile device 53 with the Bluetooth transceiver 15 can be indicated by a button 52 or a similar input. Accordingly, the CPU 3 is instructed that “the in-vehicle Bluetooth transceiver will be paired with the Bluetooth transceiver in the mobile device.”

Data may be transmitted between the CPU 3 and the network 61 by using, for example, a data plan associated with the mobile device 53, data over voice, or DTMF tones. Optionally, it may be desirable to include an in-vehicle modem 63 having an antenna 18 to facilitate transmitting data (16) between the CPU 3 and the network 61 over a voice band. The mobile device 53 can then be used to communicate (59) with the network 61 external to the vehicle 31 by means of, for example, communication (55) with the cellular tower 57. In some embodiments, the modem 63 can establish communication (20) with the cellular tower 57 so as to communicate with the network 61. As a non-limiting example, the modem 63 may be a USB cellular modem and the communication 20 may be cellular communication.

In an illustrative embodiment, the processor is provided with an operating system including an API for communicating with modem application software. The modem application software can access an embedded module or firmware on the Bluetooth transceiver so as to complete wireless communication with a remote Bluetooth transceiver (e.g., provided in the mobile device). Bluetooth is a subset of the IEEE 802 PAN (Personal Area Network) protocol. The IEEE 802 LAN (Local Area Network) protocol includes WiFi and has considerable cross-functions with the IEEE 802 PAN. The two are both suitable for wireless communication within the vehicle. Another communication method that can be used in the art is free space optical communication (such as IrDA) and non-standardized consumer IR protocol.

In another embodiment, the mobile device 53 includes a modem for voice band or broadband data communication. In an embodiment of the data over voice, when an owner of the mobile device 53 can speak through the device while the data is being transmitted, a technique known as frequency division multiplexing can be implemented. At other times, when the owner is not using the mobile device, data transmission can use the entire bandwidth (in an example, 300 Hz to 3.4 kHz). Although frequency division multiplexing is common and still used for analog cellular communication between a vehicle and the Internet, frequency division multiplexing has been replaced to a great degree by a mixture of the following used for digital cellular communications: code domain multiple access (CDMA), time domain multiple access (TDMA), and spatial domain multiple access (SDMA). These are all standards compatible with ITU IMT-2000 (3G) and provide data rates of up to 2 mbs for stationary or walking users, and provides data rates of up to 385 kbs for users in moving vehicles. The 3G standards are now being replaced by IMT-Advanced (4G), where the IMT-Advanced (4G) provides a data rate of 100 mbs for users in vehicles, and provides a data rate of 1 gbs for stationary users. If the user has a data plan associated with the mobile device 53, then the data plan can allow broadband transmission, and the system can use a much wider bandwidth (accelerating data transmission). In another embodiment, the mobile device 53 is replaced by a cellular communication device (not shown) that is mounted to the vehicle 31. In another embodiment, the mobile device (ND) 53 may be a wireless local area network (LAN) device capable of communicating over, for example, but is not limited to, an 802.11 g network (i.e., WiFi) or a WiMax network.

In an embodiment, incoming data may pass through the mobile device 53 via the data over voice or data plan, pass through the in-vehicle Bluetooth transceiver, and enter the internal processor 3 of the vehicle. For example, in the case of some temporary data, the data can be stored on the HDD or another storage medium 7 until the data is no longer needed.

Other sources that may be connected via interface to the vehicle include the following: the personal navigation device 54 having, for example, a USB connection 56 and/or an antenna 58; the vehicle navigation device 60 having a USB 62 or another connection; the in-vehicle GPS device 24, or a remote navigation system (not shown) having the capability of connecting to the network 61. The USB is one type of serial networking protocols. IEEE 1394 (FireWire™ (Apple), i.LINK™ (Sony) and Lynx™ (Texas Instruments), EIA (Electronic Industries Association) Serial Protocol, IEEE 1284 (Centronics Port), S/PDIF (Sony/Philips Digital Interconnect Format), and USB-IF (USB Developer Forum) form the backbone of a device-to-device serial standard. Most of the protocols can be implemented for electrical communication or optical communication.

Further, the CPU 3 can communicate with other various auxiliary devices 65. These devices can be connected via a wireless connection 67 or a wired connection 69. The auxiliary devices 65 may include, but are not limited to, a personal media player, a wireless healthcare device, a portable computer, and the like.

Additionally or optionally, the CPU 3 can be connected to a vehicle-based wireless router 73 by, for example, a WiFi (IEEE 803.11) transceiver 71. This may allow the CPU 3 to be connected to a remote network within the range of the local router 73.

In addition to the exemplary processing being executed by the vehicle computing system located in the vehicle, in some embodiments, the exemplary processing may also be executed by a computing system in communication with the vehicle computing system. Such a system may include, but is not limited to, a wireless device (such as, but is not limited to, a mobile phone) or a remote computing system (such as, but is not limited to, a server) connected by a wireless device. In general, such a system may be referred to as a vehicle associated computing system (VACS). In some embodiments, specific components of the VACS may execute a specific part of the processing depending on the particular implementation of the system. By way of example, if the processing includes the step of sending or receiving information with the paired wireless device, then it is likely that the wireless device is made to not execute this part of processing because the wireless device does not “send and receive” information with itself.

In each illustrative embodiment discussed herein, an example of exemplary processing can be executed by the computing system shown. With respect to each processing, for the limited purpose of performing the processing, the computing system executing the processing can be configured as a dedicated processor to execute the processing. It is unnecessary to execute all processing, and all the processing should be understood as examples of the types of processing that can be executed. Additional steps may be added to or removed from the exemplary processing as needed. The scope of the preferred embodiments includes additional implementations where the functions may be executed not according to the shown or discussed order, including in a substantially simultaneous manner or in a reverse order according to the involved functions.

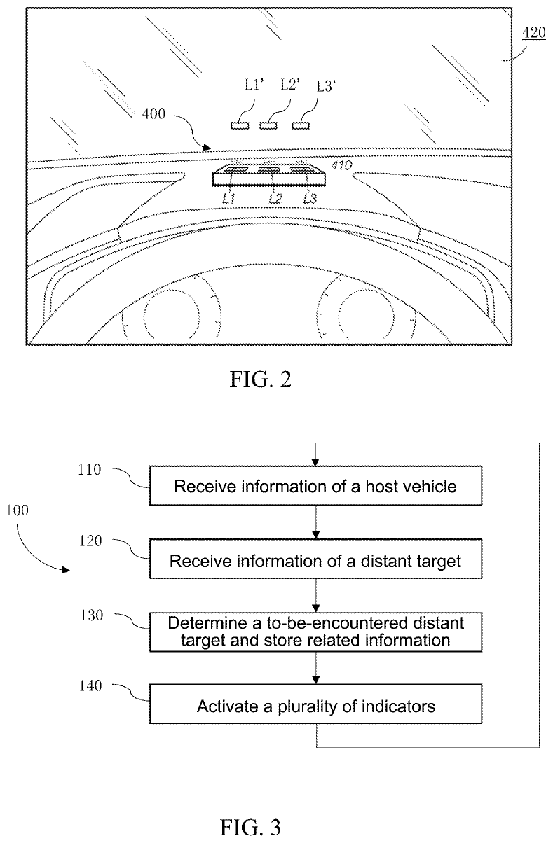

FIG. 2 schematically shows a heads-up display (HUD) 400 as an embodiment of the display 4. The heads-up display 400 includes a plurality of indicators L1, L2, and L3 located at an upper surface 410 of a console of the vehicle 31. The plurality of indicators L1, L2, and L3 may be disposed close to a front windshield 420 of the vehicle 31 and arranged substantially in a transverse direction of the vehicle 31. The plurality of indicators can emit light after being activated, thus forming an image within the sight range of a driver by reflection of the front windshield 420. As such, while driving the vehicle, the driver can receive information without moving his/her sight away from the front of the vehicle. It should be understood that although three indicators are shown in the drawing, more or fewer indicators may be included in other embodiments, such as two, four, five, and so on. L1, L2, and L3 may each include a plurality of light-emitting devices. For example, the first indicator L1 may include one LED, the second indicator L2 may include three LEDs, and the third indicator L3 may include one LED. Similarly, the plurality of indicators on the host vehicle may include more or fewer than three indicators, such as two, five, and seven. In particular, the light-emitting device of the indicators L1, L2, and L3 may use LEDs, laser projectors, or other light sources. Further, the indicator may also include pixels on a vehicle display such as a liquid crystal screen. For example, on a screen with a transverse resolution of 1024, there may be 1024 pixels or 1024 indicators in the transverse direction. In another embodiment, the plurality of indicators may also include a plurality of virtual icons located on a console screen of the host vehicle 31 or a plurality of virtual icons located on a console display, such as a liquid crystal screen, of the host vehicle 31.

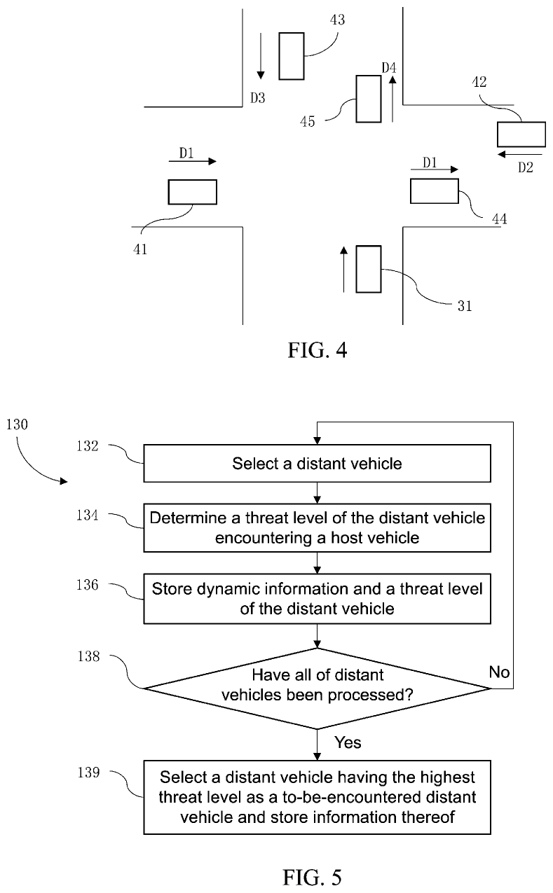

FIG. 3 and FIG. 4 schematically show an encounter warning method 100, which may be executed by a vehicle controller or CPU 3, according to one or a plurality of embodiments, including, in steps 110-130, determining an approach direction and a threat level of an approaching vehicle with respect to a host vehicle. Specifically, in the method 100, information of a host vehicle 31 is received in step 110; information of at least one distant vehicle, i.e., a target vehicle, is received in step 120; and a distant vehicle 41 is determined as an approaching vehicle and data thereof is stored in step 130. The data include an approach direction D1 and a threat level of the approaching vehicle 41 with respect to the host vehicle 31. The method 100 also includes activating the plurality of indicators sequentially in the approach direction D1 based on the threat level so as to indicate, to the driver of the host vehicle 31, the approach direction D1 and the threat level in a manner of dynamic indication in step 140.

For the purpose of illustration, the distant target is described in this specification is a motor vehicle. In one or a plurality of embodiments, the distant target may include various types of objects such as trucks, motorcycles, bicycles, electric vehicles, scooters, and pedestrians. Further, in FIG. 4, only the following are shown: the host vehicle 31 at an intersection; the distant vehicle 41 traveling rightwards from a left side of the host vehicle 31 in the direction D1, a distant vehicle 42 driving leftwards from a right side of the host vehicle 31 in a direction D2; an oncoming distant vehicle 43 driving from a front side of the host vehicle 31 in a direction D3; a distant vehicle 44 driving rightwards from the right side of the host vehicle 31 in the direction D1, and a distant vehicle 45 driving from the front side of the host vehicle 31 in the same direction D4. In an actual scenario, more or fewer distant vehicles located near the host vehicle 31 may exist. For the purpose of illustration, the description is made with reference to the intersection environment in FIG. 4. It should be understood that the host vehicle 31 may also not be located at an intersection, and distant vehicles approaching the host vehicle 31 from the front side, the rear side, or the lateral side still exist.

In step 110, the method 100 can receive a plurality of pieces of dynamic information of the host vehicle 31 via, for example, a vehicle CAN bus, Ethernet, FlexRay, and the like, including but not limited to one or a plurality of pieces of information such as speed, acceleration, moving direction, yaw rate, steering wheel angle, and throttle opening. These pieces of information can then be used, for example, to assist in determining the threat level of the host vehicle 31 encountering the distant vehicle.

In step 120, information of at least one distant target may be received. In particular, the host vehicle 31 and/or the distant vehicle may communicate with another vehicle according to a vehicle-to-vehicle (V2V) communication scheme. Alternatively, the host vehicle 31 may communicate with a pedestrian according to a vehicle-to-pedestrian (V2P) communication scheme. For example, the host vehicle 31 can transmit information to a pedestrian or receive related information from a pedestrian by means of a mobile device, a wearable device, or the like carried by the pedestrian. Alternatively or additionally, the host vehicle 31 or distant target may communicate with an infrastructure device via a vehicle-to-infrastructure (V21) communication scheme. Alternatively or additionally, the host vehicle 31 or distant target may also communicate with a cloud server via a vehicle-to-cloud server (V2C) communication scheme. For example, the host vehicle 31 or the distant target may transmit related information to another vehicle/target or receive related information from another vehicle/target either directly or via an infrastructure device, such as a communication device mounted to a bridge, a traffic control device, a road sign, etc., or via a network cloud server. Similarly, the host vehicle 31 may also receive related information of the distant target detected by an in-vehicle sensor such as a radar, a vision sensor, and an infrared sensor. In one embodiment, the system can receive dynamic information of the distant vehicle 41, including but not limited to one or a plurality of pieces of information such as oncoming vehicle direction, speed, acceleration, moving direction, yaw rate, steering wheel angle, and throttle opening.

Certainly, in other embodiments, the order of step 110 and step 120 may be interchanged, that is, the information of the distant targets is received first, and then the information of the host vehicle is received. Alternatively, step 110 and step 120 may also be executed simultaneously, that is, information of the host vehicle and the distant targets is received simultaneously.

Subsequently, in 130, the system can determine whether an approaching vehicle in the distant targets exists, and which distant target is an approaching target, and can store data thereof.

FIG. 5 schematically shows a flowchart of determining an approaching vehicle. In step 132, a distant vehicle 41 is selected; and related data of the distant vehicle may have been received in step 120. Subsequently, in 134, a threat level of the distant vehicle 41 encountering the host vehicle 31 is determined. In one embodiment, the system can approximately estimate linear movement tracks of the host vehicle 31 and the distant vehicle 41 based on current speeds and current accelerations, respectively. In another embodiment, the system can estimate movement tracks of the host vehicle 31 and the distant vehicle 41 based on the current speeds, accelerations, moving directions, yaw rates, etc., respectively. Subsequently, a track meeting point and each approaching times of moving to the track meeting point may be further determined according to the movement tracks of the two vehicles. If a difference between the approaching time of the host vehicle 31 and the approaching time of the distant vehicle 41 is less than a predetermined threshold, then it can be considered that the distant vehicle 41 has a possibility of encountering the host vehicle 31, and a threat level is further determined based on the approaching time of the distant vehicle 41. For example, it may be determined that the approaching time of the distant vehicle 41 is 3 s, and the threat level thereof is determined as a first threat level T1 accordingly. Then, in 136, the threat level T1 of the distant vehicle 41 and related dynamic information, such as the oncoming vehicle direction D1, may be stored for subsequent use.

Subsequently, in 138, it is determined whether all the distant vehicles received in step 120 have been analyzed. If not, then the method returns to step 132 to continue selecting information for a next distant vehicle (e.g., related information of the distant vehicle 42). For example, in step 134, it is determined that the approaching time of the distant vehicle 42 is 5 seconds and a threat level thereof is determined as a third threat level T3 accordingly, wherein the threat level of the distant vehicle 42 is lower than the threat level of the distant vehicle 41. In step 136, the threat level T3 of the distant vehicle 42 and related dynamic information, such as the oncoming vehicle direction D2, may be stored.

The method then proceeds to a determining block 138, and other distant vehicles, such as distant vehicles 43, 44, and 45, are sequentially processed in a cycle.

If it is determined at the determining block 138 that all of the distant vehicles around the host vehicle have been analyzed, then the method proceeds to the next step 139. In 139, a distant vehicle having the highest threat level relative to other distant vehicles is determined based on the stored threat level of the at least one distant vehicle and selected as the approaching vehicle. That is, the approaching vehicle is the one of the plurality of vehicles having a highest likelihood of a collision with the host vehicle. For example, in 139, it may be determined that the distant vehicle 41 has the highest threat level T1 relative to other distant vehicles, and therefore the distant vehicle 41 is considered as the approaching vehicle. As such, the stored threat level T1 and related dynamic information about the distant vehicle 41 are the data of the approaching vehicle, including, for example, the threat level, dynamic information, and the like, and are used by the subsequent procedure.

It should be understood that for the purpose of illustration, the threat level of each distant target is determined based on the approaching time in the above description. In other embodiments, the threat level of the distant target may also be determined based on other related information such as relative speed, distant vehicle size, target classification, and potential collision severity; and a distant target with the highest threat level may be selected as the approaching target.

In the above embodiment, a schematic non-limiting embodiment of determining the approach direction and the threat level of the approaching vehicle with respect to the host vehicle is schematically shown with reference to steps 110-130. In other embodiments, implementation may be performed in other manners. For example, a cloud processor may receive the information of the host vehicle and the distant targets; identify an approaching target that will encounter the host vehicle; and send the data of the approaching target to the host vehicle.

Returning to FIG. 3, after the approaching vehicle is determined and the data thereof is stored, the method 100 may include proceeding to step 140 so as to activate the plurality of indicators based on the threat level of the approaching vehicle and the related information thereof. As such, even if the driver of the host vehicle 31 cannot see the approaching distant vehicle due to a blocked sight or due to sunlight or weather, he/she can also become cognizant of from which direction the vehicle with the highest threat level is approaching. In an embodiment described below, the activating the plurality of indicators may include activating all of the plurality of indicators sequentially so as to display the direction and threat level of the approaching vehicle in an easily identifiable manner. In another embodiment as described elsewhere in this description, the activating the plurality of indicators may include activating a part of the plurality of indicators sequentially so as to display the direction and threat level of the approaching vehicle in an identifiable manner.

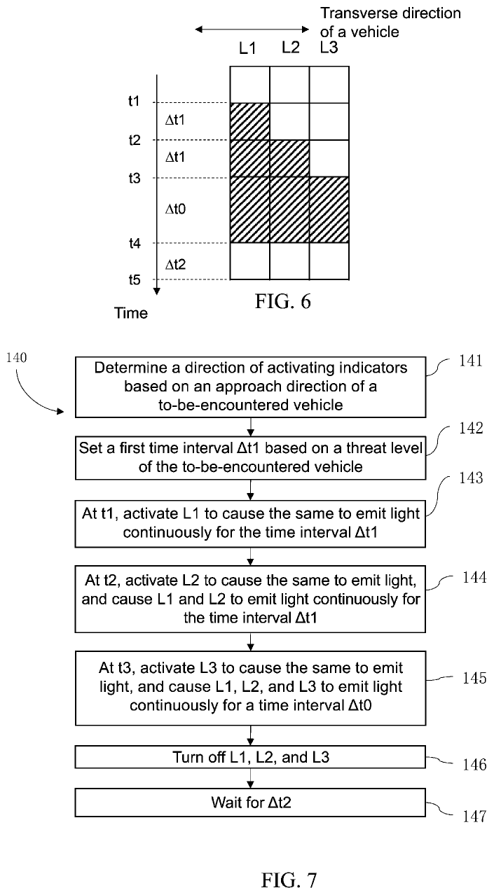

Referring to FIG. 6 and FIG. 7, FIG. 6 schematically shows a warning method of activating a plurality of indicators, in which a relationship between an order of activating indicators and the time is shown. FIG. 7 shows a flowchart of a warning method 140 of activating a plurality of indicators. Specifically, as described above and as shown in FIG. 6, a plurality of indicators disposed on the host vehicle 31 may be generally arranged in a transverse direction of the vehicle, including a first indicator L1, a second indicator L2, and a third indicator L3. For the purpose of illustration, in FIG. 6, a vertical axis represents time, and t1, t2, t3, t4, and t5 are a plurality of time points in the execution of the method. Here, an interval between t1 and t2 is Δt1, an interval between t2 and t3 is Δt1, an interval between t3 and t4 is Δt0, and an interval between t4 and t5 is Δt2. A horizontal axis represents three indicators L1, L2, and L3, with diagonal lines indicating that the indicator is activated. It should be understood that in the illustrative embodiment shown in FIG. 6, before the time point t1, none of the three indicators L1, L2, and L3 emits light; between the time points t1 and t2, the first indicator L1 emits light; between the time points t2 and t3, the first indicator L1 and the second indicator L2 emit light; between the time points t3 and t4, the three indicators L1, L2, and L3 all emit light and can last for a certain time interval Δt0; after the time point t4, none of the three indicators L1, L2, and L3 emits light. As described below, in this embodiment, the first time interval Δt1 may be determined based on the threat level of the approaching vehicle. In response to the higher threat level of the approaching vehicle, the first time interval Δt1 may be set to be shorter, such as 50 ms and 100 ms; in response to the lower threat level of the distant vehicle, the first time interval Δt1 may be set to be longer, such as 200 ms and 300 ms. Δt0 and Δt2 may be preset values, which may be equal to or not equal to the first time interval Δt1, respectively. Δt2 may be further set to 0 ms. As described above, in one or a plurality of embodiments, the indicator may include pixels on a vehicle display such as a liquid crystal screen; accordingly, shorter time intervals Δt0, Δt1, and Δt2 can be set, such as 1 ms to 10 ms.

Referring to FIG. 7, a method 140 starts from step 141 in which a direction of activating a plurality of indicators is determined based on an approach direction of an approaching vehicle. For example, in the embodiment described above, the method 130 includes storing an oncoming vehicle direction of the approaching vehicle 41 as D1 (from left to right) in step 139. Therefore, in step 141, it is determined that a plurality of indicators is activated in the direction D1. In other words, it is determined that a first indicator L1, a second indicator L2, and a third indicator L3 are activated sequentially from left to right.

Subsequently, in step 142, a first time interval Δt1 is determined based on the threat level of the approaching vehicle. For example, in the embodiment described above, the threat level of the approaching vehicle 41 is stored as T1 in step 139. Accordingly, the first time interval Δt1 can be set to 150 ms corresponding to T1 in step 142. It should be understood that in some embodiments, different first time intervals may be set for different threat levels. If the approaching vehicle has a threat level above a threshold, then the first time interval may be set to be shorter, for example 100 ms or shorter; if the approaching vehicle has a threat level below the threat threshold, then the first time interval may be set to be longer, for example 200 ms or longer. As such, the degree of urgency of an approaching vehicle approaching the host vehicle can be intuitively and visually shown. Moreover, because the relatively short first time interval is set, the activation process of the plurality of indicators can be completed in a short time, and the driver does not need to stare at the indicators for a long time to become cognizant of the oncoming vehicle direction and the degree of urgency. Certainly, longer or shorter time intervals can be set as needed, such as 50 ms, 250 ms, and 300 ms.

Subsequently, as shown in FIG. 7, in step 143, the method 140 includes activating/turning on the first indicator L1 at the time point t1 to cause the same to emit light continuously for the time period Δt1. Subsequently, in step 144, the method 140 includes turning on the second indicator L2 at the time point t2 to cause the same to emit light, and simultaneously causing the first indicator L1 and the second indicator L2 to emit light continuously for the time period Δt1. Subsequently, in step 145, the method 140 includes turning on the third indicator L3 at the time point t3 to cause the same to emit light, and simultaneously causing the first indicator L1, the second indicator L2, and the third indicator L3 to emit light continuously for a certain time interval Δt0. For the sake of simplicity, Δt0 is shown to be longer than Δt1 in FIG. 6. Δt0 can also be set to be shorter than or identical to Δt1 as needed. In step 146, the method 140 includes turning off the three indicators L1, L2, and L3 at the time point t4, and in step 147, the method 140 includes waiting for a certain time interval Δt2 until the plurality of indicators are activated again. In this embodiment, Δt2 may be equal or unequal to Δt1. With such a manner, the light emitted by the plurality of indicators presents a light strip that rapidly grows and from left to right in the oncoming vehicle direction, and the light strip flows rightwards so that the driver is intuitively aware of the direction of the oncoming vehicle driving from left to right. Moreover, the setting of Δt1 allows for different flowing speeds of the light strip; when the light strip flows at a higher speed, it is indicated that the threat level of the host vehicle and the approaching is becoming higher. That is, the growth speed of the light strip displayed by the plurality of indicators is related to the threat level of the approaching vehicle, thereby effectively warning the driver of the oncoming vehicle direction and the degree of urgency.

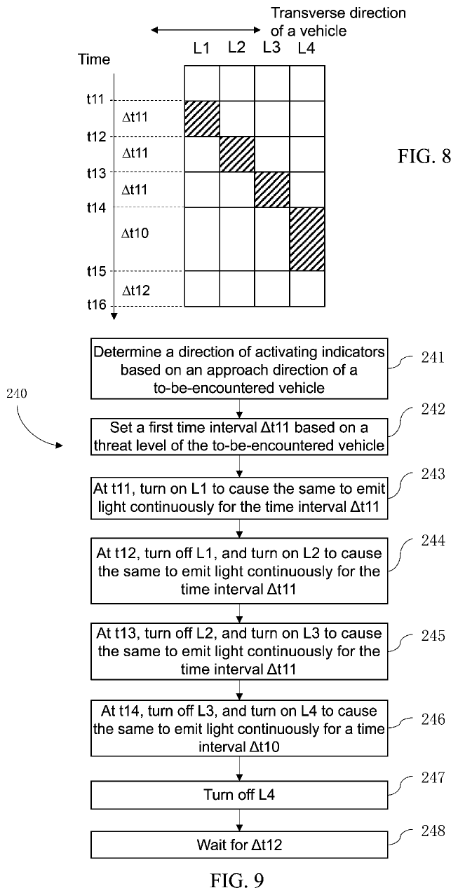

FIG. 8 schematically shows a warning method of activating a plurality of indicators L1, L2, L3, and L4, in which a relationship between an order of activating the indicators and the time is shown. FIG. 9 shows a flowchart of a warning method 240 of activating a plurality of indicators. Here, in the case where a plurality of indicators is activated sequentially, the plurality of indicators are further closed sequentially. As described below, in this embodiment, a first time interval Δt11 may be determined based on the threat level of the approaching vehicle. Δt10 and Δt12 may be preset values, and may each be equal or unequal to the first time interval Δt11. Δt12 can be further set to 0. The method 240 starts from step 241 in which a direction of activating a plurality of indicators is determined based on an approach direction of an approaching vehicle. For example, according to the oncoming vehicle direction of the distant vehicle 41 being D1 (from left to right), the method 240 includes activating the first indicator L1, the second indicator L2, the third indicator L3, and the fourth indicator L4 sequentially from left to right so as to indicate the direction from left to right. Subsequently, in step 242, the method 240 includes determining the first time interval Δt11 based on the threat level of the approaching vehicle. In step 243, the method 240 includes activating the first indicator L1 at the time point t11 to cause the same to emit light continuously for the time period Δt11. Subsequently, in step 244, the method 240 includes: at the time point t12, turning off the first indicator L1, and turning on the second indicator L2 to cause the same to emit light continuously for the time period Δt11. Subsequently, in step 245, the method 240 includes: at the time point t13, turning off the second indicator L2, and turning on the third indicator L3 to cause the same to emit light continuously for the time period Δt11. Subsequently, in step 246, the method 240 includes: at the time point t14, turning off the third indicator L3, and turning on the fourth indicator L4 to cause the same to emit light continuously for a certain time interval Δt10. For the sake of simplicity, in FIG. 8, Δt10 is shown to be longer than Δt11. Δt10 can also be set to be shorter than or identical to Δt11 as needed. Finally, the method 240 includes turning off the fourth indicator L4 at the time point t14 in step 247, and waiting for Δt20 in step 248 until the plurality of indicators are turned on again. With such a manner, the light emitted by the plurality of indicators is presented as a marker that moves rapidly from left to right in the oncoming vehicle direction, and the marker moves rightwards so that the driver is intuitively aware of the direction of the oncoming vehicle driving from left to right. Moreover, the setting of Δt11 results in different moving speeds of the marker, and the higher the moving speed, the higher the threat level of the approaching distance. That is, the moving marker displayed by the plurality of indicators is related to the threat level of the approaching vehicle, thereby effectively warning the driver of the oncoming vehicle direction and the degree of urgency. For the sake of simplicity, in this embodiment, the first indicator is turned off at the time point of turning on the second indicator; the second indicator is turned off at the time point of turning on the third indicator; and the third indicator is turned off at the time point of turning on the fourth indicator. That is, a single indicator emitting light is always present. In an alternative embodiment, the plurality of indicators can be configured to simultaneously emit light. For example, the first indicator can be turned off when the third indicator is turned on (i.e., at the time point t13), and then sequentially, the second indicator is turned off at the time point t14, and the third indicator is turned off at the time point t15. As such, two indicators emitting light are actuated. As such, the light emitted by the plurality of indicators is presented as a marker that moves rapidly from left to right in the oncoming vehicle direction, and the marker is formed by two indicators. Similarly, in other embodiments, an unfixed number of indicators may be used for simultaneous display. For example, only a single indicator emits light at first, then three indicators emit light simultaneously, and then two indicators emit light.

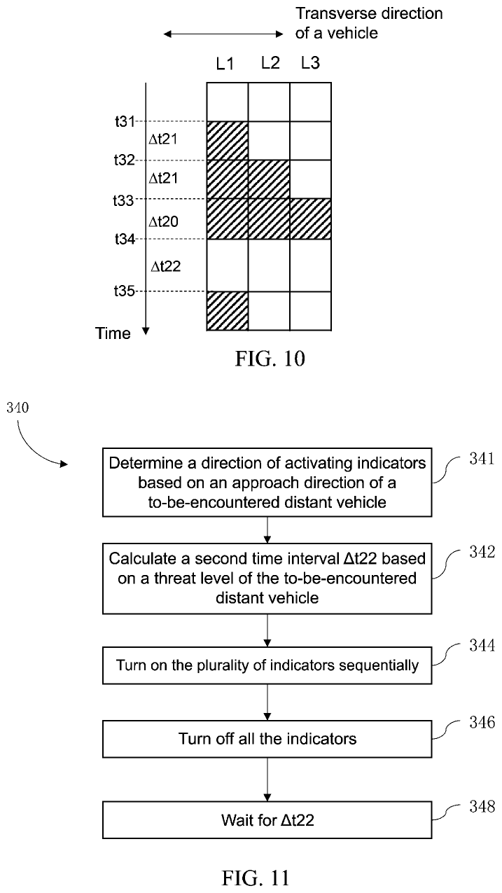

FIG. 10 schematically shows a warning method of activating a plurality of indicators, in which a relationship between an order of activating the indicators and the time is shown. FIG. 11 shows a flowchart of a warning method 340 of activating a plurality of indicators. As described below, in this embodiment, a second time interval Δt22 may be determined based on a threat level of an approaching vehicle. In response to a higher threat level of the approaching vehicle, the second time interval Δt22 may be set to be shorter, such as 50 ms and 100 ms; and in response to a lower threat level of the approaching vehicle, the second time interval Δt22 may be set to be longer, such as 300 ms and 400 ms. Δt20 and Δt21 may be preset values, which may be equal or unequal to the second time interval Δt22, respectively.

Specifically, the method 340 starts from step 341 in which a direction of activating a plurality of indicators is determined based on an approach direction of an approaching vehicle. For example, a first indicator L1, a second indicator L2, and a third indicator L3 will be activated from left to right according to an oncoming vehicle direction of the approaching vehicle 41 being D1 (from left to right). Subsequently, in step 342, a second time interval Δt22 is determined based on the threat level of the approaching vehicle. For example, in the embodiment described above, the threat level of the approaching vehicle 41 is stored as T1 in step 139. Accordingly, in step 342, the method 340 includes setting the second time interval Δt22 to 300 ms corresponding to T1. It should be understood that in some embodiments, different second time intervals Δt22 may be set for different threat levels. If the approaching vehicle has a high threat level such as T1, the second time interval Δt22 may be set to be short, such as 300 ms. If the approaching vehicle has a low threat level such as T3, the second time interval Δt22 may be set to be long, such as 400 ms. If the approaching vehicle has a higher threat level, the second time interval Δt22 may be set to 200 ms or shorter. As such, the degree of urgency of an approaching vehicle approaching the host vehicle can be intuitively and visually shown. Moreover, because the relatively short second time interval Δt22 is set, the activation process of the plurality of indicators can be repeated in a short time, and the driver does not need to stare at the indicators for a long time to become cognizant of the oncoming vehicle direction and the degree of urgency. Certainly, longer or shorter time intervals can be set as needed, such as 0 ms, 100 ms, 500 ms, and 1 s.

In step 344, the method 340 includes sequentially turning on the plurality of indicators L1, L2, and L3. The turning on the plurality of indicators sequentially may include turning on the first indicator L1 at a time point t31 to cause the same to emit light continuously for a time period Δt21; then at a time point t32, turning on the second indicator L2 to cause the same to emit light while keeping the first indicator L1 emitting light continuously; waiting for Δt21, that is, the first indicator L1 and the second indicator L2 emitting light continuously for the time period Δt21; and then at a time point t33, turning on the third indicator L3 to cause the same to emit light and simultaneously causing the first indicator L1, the second indicator L2, and the third indicator L3 to emit light continuously for a time period Δt20, that is, the first indicator L1, the second indicator L2, and the third indicator L3 emitting light continuously for the time period Δt20. For the sake of simplicity, in FIG. 10 Δt20 is shown to be longer than Δt21. Δt20 can also be set to be shorter than or identical to Δt21 as needed. Subsequently, in step 346, the method 340 includes turning off the three indicators L1, L2, and L3 at a time point t34, and in step 348, the method 340 includes waiting for Δt22 so that the plurality of indicators is turned off for the second time interval Δt22. Steps 341 to 348 are repeated in the method 340. With such a manner, the plurality of indicators presents a light strip that rapidly grows from left to right in the oncoming vehicle direction, and the time interval Δt22 between the repeated growth of the light strip is related to the threat level of the approaching vehicle. The higher the threat level, the shorter the interval between the repeated growth of the light strip, thereby effectively warning the driver of the oncoming vehicle direction and the degree of urgency.

The control of the plurality of indicators is described above with reference to the approaching target approaching the host vehicle from the left side. In other embodiments, the approaching target may also approach the host vehicle from other directions of the host vehicle, such as the left side. Accordingly, the plurality of indicators can be controlled to be activated sequentially in a direction from right to left so as to indicate that the approaching target is approaching the host vehicle from the right side. Similarly, the first time interval or the second time interval can be set based on the threat level of the approaching target.

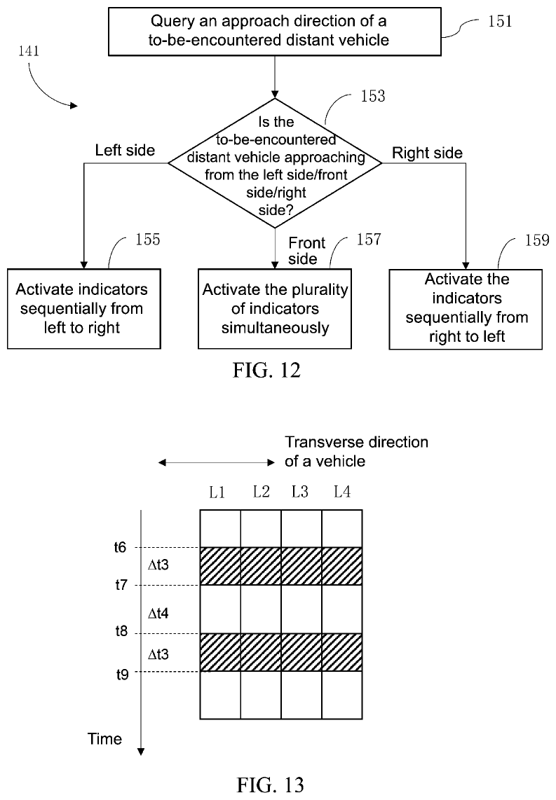

FIG. 12 shows a method 141 of determining a direction of activating indicators based on an approach direction of an approaching vehicle. The method 141 starts from step 151 in which an approach direction of an approaching vehicle is obtained. The approach direction can be stored in a memory of the vehicle or system in the preceding procedure (e.g., step 139). Subsequently, in step 153, it is determined whether the approaching vehicle is approaching the host vehicle from the left side, right side, or front side of the host vehicle.

If the approaching vehicle is generally approaching the host vehicle from the left side of the host vehicle, then the method 141 includes determining to activate a plurality of indicators sequentially from left to right in step 155. If the approaching vehicle is generally approaching the host vehicle from the right of the host vehicle, then the method 141 includes determining to activate the plurality of indicators sequentially from right to left in step 159. If the approaching vehicle is generally approaching the host vehicle from the front side of the host vehicle, then the method 141 includes determining to activate all of the indicators in step 157. It should be understood that the approaching vehicle approaching the host vehicle from the front side of the host vehicle includes a variety of cases, for example, but not limited to, the approaching vehicle approaching towards the host vehicle from the front side of the host vehicle; the approaching vehicle traveling ahead of the host vehicle in the same direction as the host vehicle at a speed lower than that of the host vehicle; and the like.

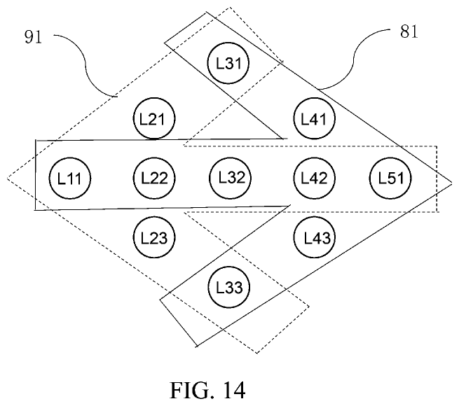

After it is determined in step 157 that all of the indicators should be activated, the method 141 includes controlling the plurality of indicators L1, L2, and L3 by a similar existing forward collision warning system. For example, referring to FIG. 13, in one embodiment, the plurality of indicators can be turned on simultaneously at a time point t6 to emit light together for a time period Δt3, then all of the plurality of indicators are turned off at a time point t7 for a time period Δt4, and then the plurality of indicators are turned on simultaneously at a time point t8 to repeat the process several times, wherein Δt3 and/or Δt4 can be determined based on a threat level of an approaching vehicle. As such, when the driver finds that the plurality of indicators of the warning system are blinking simultaneously, he/she can become cognizant that there is an approaching vehicle in front of the host vehicle, thereby correspondingly taking measures such as deceleration and lane change.

As previously described in this description, in one or a plurality of embodiments, the activating a plurality of indicators may include activating a part of the plurality of indicators. As shown in FIG. 14, a plurality of indicators are shown, and the plurality of indicators are configured to display a leftward or rightward arrow in different light-emitting modes. The plurality of indicators include light-emitting LED devices L11, L21, L22, L23, L31, L32, L33, L41, L42, L43, and L51. As shown, the plurality of indicators include a first set of LED lights 81 generally arranged in a transverse direction of the vehicle, including L11, L22, L31, L32, L33, L41, L42, L43, and L51. For the purpose of illustration, the first set of LED lights 81 are shown in solid lines. Similarly, a second set of LED lights 91 generally arranged in the transverse direction of the vehicle, including L51, L42, L31, L32, L33, L21, L22, L23, and L11, are also included. For the purpose of illustration, the second set of LED lights 91 are shown in dashed lines. The first set of LED lights 81 and the second set of LED lights 91 have shared LED lights L11, L22, L31, L32, L33, L42, and L51. In the first set of LED lights 81, the first indicator may include L11, the second indicator may include L22, the third indicators may include L31, L32, and L33, and the fourth indicators may include L41, L42, and L43, and the fifth indicator may include L51. The first, second, third, fourth, and fifth indicators are arranged substantially in the transverse direction of the vehicle. In the second set of LED lights 91, the first indicator may include L11, the second indicators may include L21, L22, and L23, the third indicators may include L31, L32, and L33, the fourth indicator may include L42, and the fifth indicator may include L51. The first, second, third, fourth, and fifth indicators are arranged substantially in the transverse direction of the vehicle. In other embodiments, depending on the different indicator layouts, the first set of LED lights and the second set of LED lights can also be independent of each other and not have any shared LED light. The first set of LED lights 81 and the second set of LED lights 91 may be disposed close to the front window of the vehicle and constitute at least a part of the HUD.

When it is determined that the approaching vehicle is approaching the host vehicle from the left side of the host vehicle as described above, a part of the plurality of indicators, i.e., the first set of LED lights 81 may be activated sequentially from left to right. Specifically, the first indicator L11 of the first set of LED lights may be turned on first, and then the second indicator L22 of the first set of LED lights, the third indicators L31, L32, and L33 of the first set of LED lights, the fourth indicators L41, L42, and L43 of the first set of LED lights, and the fifth indicator L51 of the first set of LED lights are sequentially turned on subsequently; wherein there may be a corresponding time interval between the sequential activation of the plurality of indicators as described above. As such, an arrow pointing rightwards that gradually becomes longer from left to right can be presented to the driver. If it is determined that the approaching vehicle is approaching the host vehicle from the right side of the host vehicle, then a part of the plurality of indicators, that is, the second set of LED lights 1, may be activated sequentially from right to left. Specifically, the fifth indicator L51 of the second set of LED lights may be turned on first, and then the fourth indicator L42 of the second set of LED lights, the third indicators L31, L32, and L33 of the second set of LED lights, the second indicators L21, L22, and L23 of the second set of LED lights, and the first indicator L11 of the second set of LED lights are sequentially turned on subsequently; wherein there may be a corresponding time interval between the sequential activation of the plurality of indicators as described above. As such, an arrow pointing leftwards that gradually becomes longer from right to left can be presented to the driver.

The encounter warning method intuitively and visually prompts a driver of an approach direction of a distant target in a manner of motion display (e.g., a flashing light strip or a moving marker), and displays the approach direction dynamically and differentially based on an emergency level of the distant target. The driver does not need to stare at the indicators for a long time, thus enhancing user experience.

As set forth in this description, the present disclosure provides an encounter warning method for a vehicle through one or a plurality of embodiments. However, it should be understood that those skilled in the art can make various changes, modifications and variations in the specific embodiments without departing from the spirit and scope defined by the claims.

These claims may refer to “a” or “first” element or similar features. Such claims should be construed as including one or a plurality of such elements, neither requiring nor excluding two or more of such elements. Other combinations and sub-combinations of the described features, functions, elements and/or characteristics may be claimed by modifications on the current claims or by proposal in the present application or related applications. Such claims, whether broader than, narrower than, equivalent to, or different from the original claims, should be construed as falling within the subject of the present disclosure.

1.-20. (canceled)

21. An encounter warning method, comprising:
determining an approach direction and a threat level of an identified target approaching a host vehicle; and
activating a plurality of indicators sequentially in the approach direction based on the threat level.

22. The warning method according to claim 21, wherein determining the approach direction and the threat level of the target further comprises:
collecting data of the host vehicle;
collecting data of a plurality of targets; and
identifying one of the targets from the plurality of targets as the approaching target.

23. The warning method according to claim 22, wherein identifying the approaching target further comprises:
determining a threat level of the host vehicle encountering the plurality of targets based on the data of the host vehicle and the plurality of targets; and
determining the approaching target from the plurality of targets based on the threat level.

24. The warning method according to claim 21, further comprising determining a time interval based on the threat level, actuating the plurality of indicators sequentially at the time interval according to the approach direction, and then deactivating the plurality of indicators.

25. The warning method according to claim 21, wherein the plurality of indicators includes a first indicator, a second indicator, and a third indicator arranged in a transverse direction of the host vehicle, the activating the plurality of indicators sequentially based on the threat level including:
determining a first time interval based on the threat level;
at a first time, enabling the first indicator to emit light continuously for the first time interval;
at a second time, enabling the second indicator to emit light continuously for the first time interval;
at a third time, enabling the third indicator to emit light continuously for a certain time interval; and
at a fourth time, causing the first indicator, the second indicator, and the third indicator to be turned off.

26. The warning method according to claim 21, wherein the plurality of indicators includes a first indicator, a second indicator, and a third indicator arranged in a transverse direction of the host vehicle, the activating the plurality of indicators sequentially based on the threat level including:
determining a first time interval based on the threat level;
at a first time, enabling the first indicator to emit light continuously for the first time interval;
at a second time, causing the first indicator to stop emitting light and simultaneously enabling the second indicator to emit light continuously for the first time interval;
at a third time, causing the second indicator to stop emitting light and simultaneously enabling the third indicator to emit light continuously for a certain time interval; and
at a fourth time, causing the first indicator, the second indicator, and the third indicator to be turned off.

27. The warning method according to claim 24, wherein the time interval is between 100 ms and 200 ms.

28. The warning method according to claim 24, wherein the plurality of indicators includes a first set of LED lights and a second set of LED lights arranged proximal to a front window of the vehicle, the turning on the plurality of indicators sequentially in the approach direction at the time interval including:
turning on the first set of LED lights sequentially at the time interval from left to right in response to the approaching target approaching the host vehicle from a left side of the host vehicle so that the first set of LED lights emit light presenting a rightward arrow; and
turning on the second set of LED lights sequentially at the time interval from right to left in response to the approaching distant target approaching the host vehicle from a right side of the host vehicle so that the second set of LED lights emit light presenting a leftward arrow.

29. The warning method according to claim 21, further comprising activating the plurality of indicators simultaneously upon determining the approaching target approaching the host vehicle from a front side of the host vehicle.

30. The warning method according to claim 21, wherein the activating a plurality of indicators sequentially based on the threat level includes turning on the plurality of indicators sequentially at a first time interval, and then causing the plurality of indicators for a second time interval to be turned off, wherein the second time interval is determined based on the threat level.

31. A vehicle encounter warning system, comprising:
a plurality of indicators; and
a controller programmed to:
receive information of a host vehicle;
receive data of an approaching target, the data including an approach direction and a threat level of the approaching target with respect to the host vehicle; and
activate the plurality of indicators sequentially in the approach direction based on the threat level according to a moving pattern indicating the approach direction.

32. The vehicle encounter warning system according to claim 31, wherein the plurality of indicators are arranged proximal to a front windshield of the vehicle and arranged in a transverse direction of the host vehicle, and the controller is further programmed to activate the plurality of indicators sequentially from left to right in response to the approaching target approaching the host vehicle from a left side of the host vehicle, and activate the plurality of indicators sequentially from right to left in response to the approaching target approaching the host vehicle from a right side of the host vehicle.

33. The vehicle encounter warning system according to claim 32, wherein the controller is further programmed to activate the plurality of indicators simultaneously upon determining the approaching target approaching the host vehicle from a front side of the host vehicle.

34. The vehicle encounter warning system according to claim 31, wherein the activating the plurality of indicators sequentially based on the threat level includes determining a first time interval based on the threat level, turning on the plurality of indicators sequentially at the first time interval, and then causing the plurality of indicators to be turned off.

35. The vehicle encounter warning system according to claim 31, wherein the activating the plurality of indicators sequentially based on the threat level includes turning on the plurality of indicators sequentially at a first time interval, and then causing the plurality of indicators for a second time interval to be turned off, wherein the second time interval is determined based on the threat level.

36. The vehicle encounter warning system according to claim 31, wherein the plurality of indicators includes a first set of LED lights and a second set of LED lights arranged generally in a transverse direction of the host vehicle, the first set of LED lights and the second set of LED lights form a part of a heads-up display, and the activating the plurality of indicators sequentially in the approach direction includes activating the first set of LED lights sequentially from left to right in response to the to-be-encountered distant target approaching the host vehicle from a left side of the host vehicle, and activating the second set of LED lights sequentially from right to left in response to the to-be-encountered distant target approaching the host vehicle from a right side of the host vehicle.

37. The vehicle encounter warning system according to claim 36, wherein the first set of LED lights and the second set of LED lights have at least partially shared LED lights.

38. The vehicle encounter warning system according to claim 31, wherein the plurality of indicators comprise a plurality of virtual icons located on a display of the host vehicle.

39. A vehicle encounter warning method, comprising:
determining an approach direction of an approaching target with respect to a host vehicle;
determining a threat level of the approaching target with respect to the host vehicle;
turning on a plurality of indicators sequentially from left to right at a first time interval in response to the determination that the approaching target is approaching the host vehicle from a left side of the host vehicle and the determined threat level is below a threat level threshold, and turning on the plurality of indicators sequentially from left to right at a second time interval in response to the determination that the approaching target is approaching the host vehicle from the left side of the host vehicle and the determined threat level is above the threat level threshold, the second time interval being shorter than the first time interval; and
turning on the plurality of indicators sequentially from right to left at the first time interval in response to the determination that the approaching target is approaching the host vehicle from a right side of the host vehicle and the determined threat level is below the threat level threshold, and turning on the plurality of indicators sequentially from right to left at the second time interval in response to the determination that the approaching target is approaching the host vehicle from the right side of the host vehicle and the determined threat level is above the threat level threshold.

40. The vehicle encounter warning method according to claim 39, further comprising activating the plurality of indicators simultaneously upon determining that the approaching target is approaching the host vehicle from a front side of the host vehicle.
